(19) United States
(12) Patent Application Publication
(10) Pub. No.: US 2010/0227174 A1
(43) Pub. Date: Sep. 9, 2010

(54) POLYURETHANE COMPOSITION COMPRISING TERTIARY AMINES AND ANHYDRIDOSILANES

(75) Inventors: Sabine Erdelt, Zurich (CH); Michael Schlumpf, Stallikon (CH); Urs Burckhardt, Zurich (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/451,822

(22) PCT Filed: Jul. 3, 2008
(86) PCT No.: PCT/EP2008/058559

§ 371 Date: Apr. 7, 2010

(30) Foreign Application Priority Data
Jul. 3, 2007 (EP) 07111647.9

(51) Int. Cl. B32B 27/40; C08L 75/04; B05D 3/02; C09J 5/00

(52) U.S. Cl. 428/423.1; 525/452; 524/589; 427/385.5; 427/389.7; 427/393.6; 427/393; 427/388.1; 427/393.5; 156/305

(57) ABSTRACT

The present invention relates to polyurethane compositions which are based on polyurethane polymers having isocyanate groups and comprise at least one tertiary amine and an anhydridosilane. Such compositions are suitable especially as elastic adhesives, sealants and coatings for glass and ceramic substrates. They are notable in that, with optimal adhesive properties, they are employable within a wide temperature range, including the low-temperature range, and additionally have a very good storage stability.

### TECHNICAL FIELD

The invention relates to the field of polyurethane compositions which are used especially as elastic adhesives, sealants and coatings on glass or ceramic substrates.

### STATE OF THE ART

Compositions based on polyurethane polymers having isocyanate groups have been used for some time as elastic adhesives, sealants and coatings. To improve the adhesion thereof on different substrates, they are typically used in combination with adhesion promoter compositions, known as adhesive undercoats or primers. These very often comprise, as adhesion-promoting substances, organosilanes which have a functional group reactive toward the isocyanate groups of the polyurethane polymer, for example an amino or mercapto group, on a hydrocarbon radical. Such adhesion promoter compositions comprising organosilanes are described, for example, in WO 2005/059056 A1 and are especially suitable for the improvement of the adhesion of polyurethane compositions on glass and/or ceramic substrates.

For different reasons, it may, however, be necessary or significantly advantageous to dispense with adhesion promoter compositions in the form of undercoats in the use of polyurethane compositions. In order that, nevertheless, no adhesion losses occur, adhesion-promoting substances, especially one or more organosilanes, are added to these compositions. The organosilanes used are those whose functional groups are not reactive at room temperature toward the isocyanate groups present in the polyurethane compositions, since the organosilanes can otherwise react prematurely with the polyurethane polymer and consequently lose their adhesion-promoting properties and/or even cause the composition to cure. Owing to these problems, the selection of possible organosilanes is highly restricted. For adhesion to glass or ceramic substrates, epoxysilanes in particular have been used successfully to date.

In order to accelerate the curing reaction of polyurethane polymers having isocyanate groups, or in order to enable curing even in the low-temperature range, tertiary amines are typically used as catalysts in such polyurethane compositions. A significant disadvantage of such systems is the poor compatibility of epoxysilanes with tertiary amine catalysts, which leads to the effect that the compositions can cure as early as in the course of storage and often within the specified use time of the composition.

### SUMMARY OF THE INVENTION

It is therefore an object of the present invention to provide compositions based on polyurethane polymers having isocyanate groups, which have high storage stability and good adhesion to glass and ceramic substrates in the presence of tertiary amine catalysts, these substrates not having been pretreated by means of undercoats.

It has now been found that, surprisingly, compositions according to claim 1 achieve this object.

The inventive compositions have very good storage stability and good adhesion, especially on glass and ceramic substrates. They can be applied within a very broad temperature range, especially also in the low-temperature range, for example in the range from −10 to +10° C.

Further aspects of the invention are the subject of further independent claims. Particularly preferred embodiments of the invention are the subject of the dependent claims.

### Ways of Performing the Invention

The present invention provides compositions comprising

a) at least one polyurethane polymer P having isocyanate groups;
b) at least one tertiary amine;
c) at least one silane of the formula (I)

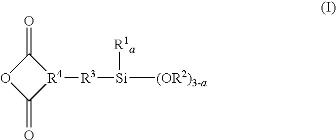

The R¹ radical here is an alkyl group having 1 to 8 carbon atoms, especially a methyl or ethyl group.

The R² radical is an alkyl group having 1 to 5 carbon atoms, especially a methyl, ethyl or isopropyl group.

R³ is a linear or branched, cyclic or acyclic alkylene group having 1 to 20 carbon atoms, optionally with aromatic moieties, and optionally with heteroatoms, especially an alkylene group having 3 carbon atoms.

R⁴ is a trivalent hydrocarbon radical having 2 to 5, especially having 2, carbon atoms.

a is 0 or 1, especially 0.

Most preferred are silanes of the formula (I) in which R² is a methyl or ethyl group, R³ is an alkylene group having 3 carbon atoms, R⁴ is a trivalent hydrocarbon radical having 2 carbon atoms and a is 0.

The silane of the formula (I) is an anhydridosilane and is commercially available, for example, under the trade name Geniosil® GF 20 from Wacker, Germany.

Substance names beginning with “poly”, for example polyisocyanate, polyurethane, polyester, polyurea, polyol or polycarbonate, refer in the present document to substances which formally contain two or more of the functional groups which occur in their name per molecule.

The term “polymer” in the present document firstly embraces a collective of macromolecules which are chemically homogeneous but different in relation to degree of polymerization, molar mass and chain length, which has been prepared by a poly reaction (polymerization, polyaddition, polycondensation). The term secondly also embraces derivatives of such a collective of macromolecules from poly reactions, i.e. compounds which have been obtained by reactions, for example additions or substitutions, of functional groups on given macromolecules, and which may be chemically homogeneous or chemically inhomogeneous. The term also embraces what are known as prepolymers, i.e. reactive oligomeric preliminary adducts whose functional groups are involved in the formation of macromolecules.

The term “polyurethane polymer” embraces all polymers prepared by the diisocyanate polyaddition process. This also includes those polymers which are virtually or completely free of urethane groups. Examples of polyurethane polymers are polyesterpolyurethanes, polyetherpolyurethanes, polyurethanepolyureas, polyureas, polyesterpolyureas, polyisocyanurates or polycarbodiimides.

The term “silane” in the present document refers to organoalkoxysilanes in which two or three alkoxy groups are firstly bonded directly to the silicon atom via an Si—O bond, and which secondly have one or two organic radicals which are or bear a functional group bonded directly to the silicon atom via an Si—C bond. The silanes have the property of being hydrolyzed on contact with moisture. This forms organosilanols and, by subsequent condensation reactions, organosiloxanes.

The composition comprises at least one polyurethane polymer P having isocyanate groups, which is typically prepared from at least one polyisocyanate and at least one polyol. This reaction can be effected by reacting the polyol and the polyisocyanate by customary processes, for example at temperatures of 50° C. to 100° C., optionally with additional use of suitable catalysts, the polyisocyanate being metered in in such a way that the isocyanate groups thereof are present in a stoichiometric excess in relation to the hydroxyl groups of the polyol. The polyisocyanate is advantageously metered in such that an NCO/OH ratio of 1.5 to 5, especially one of 1.8 to 3, is maintained. The NCO/OH ratio is understood here to mean the ratio of the number of isocyanate groups used relative to the number of hydroxyl groups used. Preferably, after the reaction of all hydroxyl groups of the polyol, a content of free isocyanate groups of 0.5 to 15% by weight, more preferably of 1.0 to 10% by weight, remains in the polyurethane polymer P.

The polyisocyanates used for the preparation of a polyurethane polymer P may be commercial aliphatic, cycloaliphatic or aromatic polyisocyanates, especially diisocyanates.

There are, for example, diisocyanates whose isocyanate groups are each bonded to an aliphatic, cycloaliphatic or arylaliphatic carbon atom, also known as “aliphatic diisocyanates”, such as 1,6-hexamethylene diisocyanate (HDI), 2-methylpentamethylene 1,5-diisocyanate, 2,2,4- and 2,4,4-trimethyl-16-hexamethylene diisocyanate (TMDI), 1,12-dodecamethylene diisocyanate, lysine diisocyanate and lysine ester diisocyanate, cyclohexane 1,3-diisocyanate, cyclohexane 1,4-diisocyanate, 1-isocyanato-3,3,5-trimethyl-5-isocyanatomethylcyclohexane (isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis(1-isocyanato-1-methylethyl)naphthalene; and diisocyanates with isocyanate groups each bonded to an aromatic carbon atom, also known as “aromatic diisocyanates”, such as 2,4- and 2,6-tolylene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI); oligomers and polymers of the aforementioned isocyanates, and any desired mixtures of the aforementioned isocyanates.

For the formulation of light-stable compositions, aliphatic diisocyanates are preferred, especially HDI and IPDI.

Among the aromatic diisocyanates, preference is given to MDI and TDI.

The polyols used for the preparation of a polyurethane polymer P may, for example, be the following commercial polyols or mixtures thereof:
polyoxyalkylenepolyols, also known as polyetherpolyols or oligoetherols, which are polymerization products of ethylene oxide, 1,2-propylene oxide, 1,2- or 2,3-butylene oxide, tetrahydrofuran or mixtures thereof, possibly polymerized with the aid of a starter molecule having two or more active hydrogen atoms, for example water, ammonia or compounds with a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexane-dimethanol, bisphenol A, hydrogenated bisphenol A, 1,1,1-trimethylolethane, 1,1,1-trimethylolpropane, glycerol, aniline, relatively short-chain polyetherpolyols and mixtures of the aforementioned compounds. It is possible to use either polyalkylenepolypols which have a low degree of unsaturation (measured to ASTM D-2849-69 and reported in milliequivalents of unsaturation per gram of polyol (meq/g)), prepared, for example, with the aid of double metal cyanide complex catalysts (DMC catalysts), or polyoxyalkylenepolyols with a higher degree of unsaturation, prepared, for example, with the aid of anionic catalysts such as NaOH, KOH, CsOH or alkali metal alkoxides;
styrene-acrylonitrile- or acrylonitrile-methyl methacrylate-grafted polyetherpolyols;
polyesterpolyols, also known as oligoesterols, prepared, for example, from di- to trihydric alcohols, for example 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or anhydrides or esters thereof, for example succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid, or mixtures of the aforementioned acids, and polyesterpolyols formed from lactones, for example ε-caprolactone;
polycarbonatepolyols as obtainable by reaction, for example, of the abovementioned alcohols—used to form the polyesterpolyols—with dialkyl carbonates, diaryl carbonates or phosgene;
polyacrylate- and polymethacrylatepolyols;
polyhydrocarbon polyols, also referred to as oligohydrocarbonols, for example poly-hydroxy-functional ethylene-propylene, ethylene-butylene or ethylene-propylene-diene copolymers, as produced, for example, by Kraton Polymers, or poly-hydroxy-functional copolymers formed from dienes such as 1,3-butadiene or diene mixtures and vinyl monomers such as styrene, acrylonitrile or isobutylene, or poly-hydroxy-functional polybutadiene polyols, for example those which are prepared by copolymerization of 1,3-butadiene and allyl alcohol and may also be hydrogenated;
poly-hydroxy-functional acrylonitrile/polybutadiene copolymers, as can be prepared, for example, from epoxides or amino alcohols and carboxyl-terminated acrylonitrile/polybutadiene copolymers (commercially available under the Hycar® CTBN name from Emerald Performance Materials, LLC., USA).

Particularly suitable are polyoxyalkylenediols or polyoxyalkylenetriols, especially polyoxypropylenediols or polyoxypropylenetriols.

Likewise particularly suitable are what are known as ethylene oxide-end capped (“EO-end capped”) polyoxypropylenepolyols. The latter are specific polyoxypropylenepolyoxyethylenepolyols which are obtained, for example, by further alkoxylating pure polyoxypropylenepolyols, especially polyoxypropylenediols and -triols, after completion of the polypropoxylation reaction, with ethylene oxide, and thus have primary hydroxyl groups.

Likewise particularly suitable are polytetrahydrofurandiols.

These polyols mentioned preferably have a mean molecular weight of 250-30 000 g/mol, especially of 400-8000 g/mol, and a mean OH functionality in the range from 1.7 to 3.

In addition to these polyols mentioned, it is possible to also use small amounts of low molecular weight di- or polyhydric alcohols in the preparation of a polyurethane polymer P, for example 1,2-ethanediol, 1,3- and 1,4-butanediol, 1,2- and 1,3-propanediol, neopentyl glycol, diethylene glycol, triethylene glycol, the isomeric dipropylene glycols and tripropylene glycols, the isomeric pentanediols, hexanediols, heptanediols, octanediols, nonanediols, decanediols, undecanediols, 1,3- and 1,4-cyclohexane-dimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned di- and polyhydric alcohols, and mixtures of the aforementioned alcohols. It is equally possible to also use small amounts of polyols with a mean OH functionality of more than 3, for example sugar polyols.

In addition, the composition comprises at least one tertiary amine. Such tertiary amines are especially selected from the group consisting of triethylamine, tributylamine, N-ethyldiisopropylamine, N,N,N′,N′-tetramethylethylenediamine, pentamethyldiethylenetriamine and higher homologs thereof, N,N,N′,N′-tetramethylpropylenediamine, pentamethyldipropylenetriamine and higher homologs thereof, N,N,N′,N′-tetramethyl-1,3-butanediamine, N,N,N′,N′-tetramethyl-1,6-hexanediamine, bis(dimethylamino)methane, N,N-dimethylbenzylamine, N,N-dimethylcyclohexylamine, N-methyldicyclohexylamine, N,N-dimethylhexadecylamine, bis(N,N-diethylaminoethyl)adipate, N,N-dimethyl-2-phenylethylamine, tris(3-dimethylaminopropyl)amine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-methylmorpholine, N-ethylmorpholine, N-cocomorpholine, N,N′-dimethylpiperazine, N-methyl-N′-dimethylaminoethylpiperazine, bis(dimethylaminoethyl)piperazine, 1,3,5-tris(dimethylaminopropyl)hexahydrotriazine or bis(2-dimethylaminoethyl)ether; aromatic nitrogen compounds such as 4-dimethylaminopyridine, N-methylimidazole, N-vinylimidazole or 1,2-dimethylamidazole; amidines and guanidines with no active hydrogen groups, such as 1,1,3,3-tetramethylguanidine, and dimorpholino ethers of the formula (II).

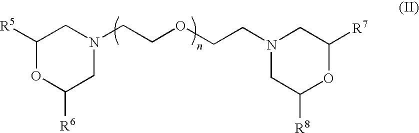

The R⁵, R⁶, R⁷ and R⁸ radicals here are each independently hydrogen atoms or methyl or ethyl groups, and n is from 1 to 10, especially from 1 to 5.

The tertiary amine is preferably selected from the group consisting of 1,4-diazabicyclo[2.2.2]octane (DABCO), 1,8-diazabicyclo[5.4.0]undec-7-ene (DBU), 1,5-diazabicyclo[4.3.0]non-5-ene (DBN) and dimorpholino ether of the formula (II).

The most preferred tertiary amine of the formula (II) is 2,2′-dimorpholinodiethyl ether (DMDEE).

The composition more preferably comprises 3-(trimethoxysilyl)propylsuccinic anhydride or 3-(triethoxysilyl)propylsuccinic anhydride as the silane of the formula (I), and 2,2-dimorpholinodiethyl ether (DMDEE) as the tertiary amine.

The proportion of the silane of the formula (I) in the overall composition is preferably 0.05 to 5% by weight, especially 0.1 to 2.5% by weight.

The proportion of the tertiary amine in the overall composition is preferably 0.05 to 3% by weight, especially 0.1 to 2% by weight.

The composition preferably further comprises a filler. The filler influences both the rheological properties of the uncured composition and the mechanical properties and the surface character of the cured composition. Suitable fillers are inorganic and organic fillers, for example natural, ground or precipitated calcium carbonates optionally coated with fatty acids, especially stearates, barium sulfate (BaSO₄, also referred to as barite or heavy spar), calcined kaolins, aluminum oxides, aluminum hydroxides, silicas, especially finely divided silicas from pyrolysis processes, carbon blacks, especially industrially produced carbon black, PVC powder or hollow spheres. Preferred fillers are calcium carbonates, calcined kaolins, carbon black, finely divided silicas and flame-retardant solids, such as hydroxides or hydrates, especially hydroxides or hydrates of aluminum, preferably aluminum hydroxide.

It is entirely possible and may even be advantageous to use a mixture a different fillers.

A suitable amount of filler is, for example, in the range from 10 to 80% by weight, preferably 15 to 60% by weight, based on the overall composition.

In addition, the composition may comprise a solvent, though it should be ensured that this solvent does not have any groups reactive with isocyanate groups, more particularly no hydroxyl groups and no other groups with active hydrogen.

Suitable solvents are especially selected from the group consisting of ketones, esters, ethers, aliphatic and aromatic hydrocarbons, halogenated hydrocarbons, and N-alkylated lactams. Examples of suitable ketones are acetone, methyl ethyl ketone, diisobutyl ketone, acetylacetone, mesityl oxide, cyclohexanone and methylcyclohexanone; examples of suitable esters are acetates such as ethyl acetate, propyl acetate and butyl acetate, formates, propionates and malonates such as diethyl malonate; examples of suitable ethers are dialkyl ethers such as diisopropyl ether, diethyl ether, dibutyl ether, diethylene glycol diethyl ether and ethylene glycol diethyl ether, ketone ethers and ester ethers; examples of suitable aliphatic and aromatic hydrocarbons are toluene, xylene, heptane, octane, and mineral oil fractions such as naphtha, white spirit, petroleum ether and benzine; halogenated hydrocarbons such as methylene chloride; and N-alkylated lactams such as N-methylpyrrolidone.

Preferred solvents are xylene, toluene, white spirit and mineral oil fractions in the boiling range from 100° C. to 200° C.

Suitable amounts of solvent are typically in the range from 0.5 to 20% by weight, especially 1 to 10% by weight, based on the overall composition.

The composition advantageously comprises at least one plasticizer. More particularly, such plasticizers are esters of organic carboxylic acids or anhydrides thereof, for example phthalates such as dioctyl phthalate, diisononyl phthalate or diisodecyl phthalate, adipates such as dioctyl adipate, azelates and sebacates; organic phosphoric and sulfonic esters, polybutenes and polyisobutenes.

It is possible for further constituents to be present in the composition. Further constituents are especially assistants and additives such as:
catalysts as customary in polyurethane chemistry, especially tin and bismuth compounds;
fibers, for example of polyethylene;
pigments, for example titanium dioxide or iron oxides;
rheology modifiers, for example thickeners or thixotropic agents, especially urea compounds, polyamide waxes, bentonites or fumed silicas;
reactive diluents or crosslinkers, for example low molecular weight oligomers and derivatives of diisocyanates such as MDI, PMDI, TDI, HDI, 1,12-dodecamethylene diisocyanate, cyclohexane 1,3-diisocyanate or cyclohexane 1,4-diisocyanate, IPDI, perhydro-2,4′-diphenylmethane diisocyanate and perhydro-4,4′-diphenylmethane diisocyanate, 1,3- and 1,4-tetramethylxylylene diisocyanate, especially isocyanurates, carbodiimides, uretonimines, biurets, allophanates and iminooxadiazinediones of the diisocyanates mentioned, adducts of diisocyanates with short-chain polyols, adipic dihydrazide and other dihydrazides, and blocked hardeners in the form of polyaldimines, polyketimines, oxazolidines or polyoxazolidines;
desiccants, for example molecular sieves, calcium oxide, high-reactivity isocyanates such as p-tosyl isocyanate, orthoformic esters, alkoxysilanes such as tetraethoxysilane, organoalkoxysilanes such as vinyltrimethoxysilane, and organoalkoxysilanes which have a functional group in the a position to the silane group;
adhesion promoters, especially silanes, for example vinylsilanes, (meth)acryloylsilanes, isocyanatosilanes, carbamatosilanes, S-(alkylcarbonyl)mercaptosilanes and aldiminosilanes, oligomeric forms of these silanes, and adducts of aminosilanes and/or mercaptosilanes with polyisocyanates;
nonreactive thermoplastic polymers, for example homo- or copolymers of unsaturated monomers, especially of unsaturated monomers which are selected from the group comprising ethylene, propylene, butylene, isobutylene, isoprene, vinyl acetate or higher esters thereof, and (meth)acrylate, ethylene-vinyl acetate copolymers (EVA), atactic poly-α-olefins (APAO), polypropylenes (PP) and polyethylenes (PE);
stabilizers against heat, light and UV radiation;
flame-retardant substances;
surface-active substances, for example wetting agents, leveling agents, deaerating agents or defoamers;
biocides, for example algicides, fungicides or substances which inhibit fungal growth;
   and further substances which are used customarily in polyurethane compositions.

It is advantageous to select all of the constituents mentioned, which are optionally present in the composition, such that the storage stability of the composition is not impaired by the presence of such a constituent, which means that the properties of the composition, especially the application and curing properties, change only to a minor degree, if at all, in the course of storage. This requires that reactions leading to the chemical curing of the composition described, especially of isocyanate groups, should not occur to a significant degree during storage. It is therefore especially advantageous that the constituents mentioned comprise, or release in the course of storage, at most traces of water, if any. It may therefore be advisable and appropriate to chemically or physically dry certain constituents before they are mixed into the composition.

The composition described is preferably stored with exclusion of moisture. As a result, the composition remains storage-stable, i.e. it can be stored with exclusion of moisture in a suitable package or arrangement, for example a drum, a pouch or a cartridge, over a period of several months up to one year and longer, without its performance properties or its properties after curing changing to a degree relevant for the use thereof. Typically, the storage stability is determined via the measurement of the viscosity, the extrusion volume or the extrusion force.

The composition is cured by virtue of the composition coming into contact with water on application. The curing reaction is also referred to as crosslinking.

The water required for the curing reaction may either originate from the air (air humidity), or else the composition can be contacted with a water-containing component, for example by spread-coating, for example with a smoothing agent, or by spray-coating, or a water-containing component can be added to the composition on application, for example in the form of a water-containing paste which is mixed in, for example, by means of a static mixer.

In the cured state, the composition possesses a high mechanical strength coupled with high extensibility, and good adhesion properties even after severe moisture stress. As a result, it is suitable for a multitude of applications, especially as an elastic adhesive, as an elastic sealant or as an elastic coating. More particularly, the composition is suitable for applications with require a high curing rate and make high demands on durability and early and final strength, and also extensibility, with simultaneously high demands on the adhesion properties. It is especially suitable for applications in which there is moisture stress on the cured composition, especially resulting from a combination of heat and moisture.

The composition described is particularly suitable as an adhesive or sealant or as a coating, especially as an elastic adhesive or sealant.

The composition described is preferentially suitable for glazing of modes of transport, especially of water or land vehicles, preferably of automobiles, buses, trucks, trains or ships, most preferably of automobiles.

The composition described is additionally preferably suitable for adhesive bonding, sealing and/or coating in construction and industrial applications, especially for sealing buildings or built structures in construction and civil engineering, both indoors and outdoors.

The composition described can be used either at room temperature or at elevated temperature, as a warm-melt or as a hot-melt composition. The different consistency and the different properties in the uncured state and in the cured state arise according to the ingredients present in the composition and the amounts thereof.

In one embodiment, the composition has, for example at room temperature, a pasty consistency and properties of structural viscosity, and is typically suitable as an adhesive and/or sealant, especially as an elastic adhesive or sealant.

In another embodiment, the composition has, at room temperature, a fluid consistency with good leveling properties. As a result, it can be applied in a simple manner as a self-leveling coating to predominantly smooth surfaces, for example as a floor covering.

In a further embodiment, the composition comprises a room temperature solid polyurethane polymer P, or a room temperature solid meltable component, which is preferably a reactive thermoplastic polymer as described above or a nonreactive thermoplastic polymer. Depending on the melting temperature of the solid components, the composition is typically used as a warm-melt composition, i.e. at a temperature between 40° C. and 80° C., or as a hot-melt composition, i.e. at a temperature of >80° C., especially of 100° C. In both cases, the application temperature is above the melting point of the solid components mentioned. As a result, the composition cures through two processes. Firstly, the composition solidifies in the course of cooling, by virtue of the molten solid component solidifying, especially by crystallization, thus greatly increasing the viscosity of the composition. In parallel and/or thereafter, the composition cures chemically by means of moisture, associated with the development of the final strength, as already described.

The invention further comprises a process for adhesive bonding substrates S1 and S2. Such a process comprises the steps of
i) applying a composition as described above to a substrate S1 and/or a substrate S2;
ii) contacting the substrates S1 and S2 through the applied composition;
iii) curing the composition by means of water, especially in the form of air humidity;
   the substrates S1 and S2 being the same or different than one another.

The invention additionally also comprises a process for sealing or for coating, comprising the steps of
i′) applying a composition as described above to a substrate S1 or between a substrate S1 and a substrate S2;
ii′) curing the composition by means of water, especially in the form of air humidity;
   the substrates S1 and S2 being the same or different than one another.

With regard to steps iii) or ii′) of the chemical curing of the composition with moisture, the person skilled in the art understands that the curing reaction, depending on factors such as the composition used, the substrates, the temperature, the ambient humidity and the adhesion geometry, can begin as early as during the application of the composition. However, the main part of the chemical curing generally takes place after the application of the composition.

Suitable substrates S1 and S2 are especially substrates which are selected from the group consisting of glass, ceramic, glass ceramic, concrete, mortar, brick, tile, gypsum, natural stone such as granite or marble, wood, metal or metal alloy such as aluminum, steel, nonferrous metal or galvanized metal, plastics such as PVC, polycarbonate, PMMA, polyester or epoxy resin, powder coating, paint or paint system, especially automotive topcoat.

Preferably, at least one of the substrates S1 and S2 is glass or ceramic, especially glass ceramic.

Most preferably, the substrates are S1 a windowpane and S2 a metal or a metal alloy, especially a painted metal or a painted metal alloy, as used in the manufacture of modes of transport, especially water or land vehicles, preferably automobiles, buses, trucks, trains or ships, most preferably automobiles.

If the composition is used as an adhesive for elastic adhesive bonds, it preferably has a pasty consistency with properties of structural viscosity. Such an adhesive is applied to the substrate by means of a suitable device, preferably in the form of a bead, which advantageously has an essentially round or triangular cross-sectional area. Suitable methods of applying the adhesive are, for example, application from commercial cartridges, which is conducted manually or by means of compressed air, or from a drum or hobbock by means of a delivery pump or of an extruder, optionally by means of an application robot. An adhesive with good application properties has high creep resistance and short stringing. This means that it remains in the form applied after application, i.e. does not flow apart, and forms only a very short thread, if any, after the application unit has been moved away, such that the substrate is not soiled.

Inventive compositions, especially without the use of adhesion promoter compositions, also known as primers, have good adhesion to glass and ceramic substrates. In addition, they have good low-temperature curing.

The present invention further comprises an article which has been adhesive bonded, sealed and/or coated with a composition described, which is obtained by one of the processes described.

These articles are preferably a built structure, especially a built structure in construction or civil engineering, or an industrial good or a consumer good, especially a window, a domestic appliance, or a mode of transport, especially a water or land vehicle, preferably an automobile, a bus, a truck, a train or a ship. Such articles are preferably installable components of a mode of transport, especially also modular parts which are used as modules on the production line and are especially attached or inserted by adhesive bonding. More particularly, these prefabricated installable components are used in the building of modes of transport. For example, such installable components are driver's cabins, of trucks or of locomotives, or sunroofs of automobiles. These articles are preferably windowpanes of modes of transport, especially windowpanes of automobiles and trucks.

### EXAMPLES

### Preparation of a Polyurethane Polymer P1

The polyurethane polymer P1 was prepared as follows: 4000 g of polyoxypropylenediol (Acclaim® 4200 N, Bayer; OH number 28.5 mg KOH/g) and 520 g of 4,4′-methylenediphenyl diisocyanate (MDI: Desmodur® 44 MC L, Bayer) were reacted at 80° C. to give a polyurethane polymer terminated by isocyanate groups with a content of free isocyanate groups, determined by titrimetric means, of 1.86% by weight.

### Preparation of the Polyurethane Composition

In a vacuum mixer, 1320 g of polyurethane polymer P, 330 g of diisodecyl phthalate (DIDP; Palatinol® Z, BASF, Germany), 15 g of a silane, 300 g of a urea thickener, the preparation of which is described in detail below, 450 g of carbon black (dried), 525 g of calcined kaolin (dried) and 60 g of a tertiary amine (2,2′-dimorpholinodiethyl ether (DMDEE)) were processed to give a homogeneous paste which was stored with exclusion of moisture.

The silane used in the reference example Ref-1 was 3-g lycidyloxypropyltrimethoxysilane (Dynasylan® GLYMO, Degussa, Germany), in Ref-2 S-(octanoyl)mercaptopropyltriethoxysilane (Gelest, Inc., USA), and in the inventive example 3-(triethoxysilyl)propylsuccinic anhydride (Geniosil® GF 20, Wacker, Germany).

The urea thickener was prepared as follows: a vacuum mixer was initially charged with 1000 g of diisodecyl phthalate (DIDP; Palatinol® Z, BASF, Germany) and 160 g of 4,4′-methylenediphenyl diisocyanate (MDI: Desmodur® 44 MC L, Bayer, Germany), which were heated gently. Then 90 g of monobutylamine were slowly added dropwise with vigorous stirring. The paste which formed was stirred under vacuum with cooling for a further hour.

### Test Methods

### Determination of the Storage Stability

The storage stability of the polyurethane compositions prepared was determined via the measurement of the extrusion force (“EF”).

For the determination of the extrusion force, the compositions were each filled into a cartridge and stored for the time and at the temperature specified in table 1, and finally conditioned at 23° C. for 12 hours and then opened. A nozzle of internal diameter 5 mm was screwed on. A “Zwick 1120” extrusion apparatus was then used to determine the force which was required to extrude the composition at an extrusion rate of 60 mm/min. The value reported is a mean of the forces measured after 22 mm, 24 mm, 26 mm and 28 mm. The measurement was stopped after 30 mm of extrusion.

### Determination of Adhesion

To test the adhesion, the polyurethane composition was applied to the substrates as a round bead with a cartridge press and a nozzle. Then the composition was cured first at a temperature of 23° C. and a relative air humidity of 50% over 7 days (room temperature climate-controlled storage: “RT”) and then at 70° C. and 100% relative air humidity over a further 7 days (hot and humid storage: “HH”).

Thereafter, the cured beads were each insized at one end just above the surface of the plate (adhesive surface). The insized end of the bead was held by hand and then pulled cautiously and slowly from the plate surface, peeling in the direction of the other end of the bead. If, in the course thereof, the adhesion was so strong that the end of the bead threatened to tear off in the course of pulling, a cut at right angles to the direction in which the bead was pulled was made down to the bare surface of the plate using a cutter and the bead was thus detached a little further. Such cuts were repeated, if necessary, at intervals of 2 to 3 mm as pulling continued. In this way, all of the bead was pulled or cut from the plate. The adhesion properties were assessed with reference to the cured composition which remained on the substrate surface after the bead had been pulled off (cohesive fracture), specifically by estimating the cohesive proportion of the adhesion surface. In the test results in table 1, the proportion of cohesive fracture is shown in percent of the total adhesion area. Cohesive fracture values of less than 75% are considered to be unsatisfactory.

The adhesion of the polyurethane compositions was determined on the following substrates:
glass specimens from Rocholl Deutschland (float glass, tested on the air side)
Ferro 14279 (VSG) and Ferro 14251 (ESG) glass ceramic specimens from Rocholl Deutschland

Before the application of the composition, the substrates were cleaned with an isopropanol/water mixture (2:1).

### Results

TABLE 1
Polyurethane compositions and results of the determination
of storage stability and of adhesion.

| | Ref-1 | | Ref-2 | | 1 | |
|---|---|---|---|---|---|---|
| PU polymer P1 [% by wt.] | 44.0 | | 44.0 | | 44.0 | |
| DIDP [% by wt.] | 12.5 | | 12.5 | | 12.5 | |
| Urea thickener [% by wt.] | 10.0 | | 10.0 | | 10.0 | |
| 3-Glycidyloxypropyltrimeth- | 0.5 | | | | | |
| oxysilane [% by wt.] | | | | | | |
| S-(Octanoyl)mercaptopropyl- | | | 0.5 | | | |
| triethoxysilane [% by wt.] | | | | | | |
| 3-(Triethoxysilyl)propylsuc- | | | | | 0.5 | |
| cinic anhydride [% by wt.] | | | | | | |
| Carbon black [% by wt.] | 15.0 | | 15.0 | | 15.0 | |
| Calcined kaolin [% by wt.] | 17.5 | | 17.5 | | 17.5 | |
| DMDEE [% by wt.] | 0.5 | | 0.5 | | 0.5 | |
| Total [% by wt.] | 100 | | 100 | | 100 | |
| EF 1 d RT [N] | 700 | | 700 | | 700 | |
| EF 7 d 60° C. [N] | 1500 | | 1200 | | 1000 | |
| EF 6 mt RT [N] | cured | | 1700 | | 1300 | |
| | through | | | | | |
| Adhesion to | RT | HH | RT | HH | RT | HH |
| Glass | 100% | 100% | <50% | <50% | 100% | 100% |
| Glass ceramic | 100% | 100% | <50% | <50% | 100% | 100% |

The results from table 1 show that the inventive composition has very good storage stability and simultaneously optimal adhesion to glass and glass ceramic.

1. A composition comprising:
a) at least one polyurethane polymer P having isocyanate groups;
b) at least one tertiary amine;
c) at least one silane of the formula (I) 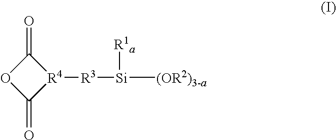
where
R¹ is an alkyl group having 1 to 8 carbon atoms, especially a methyl or ethyl group;
R² is an alkyl group having 1 to 5 carbon atoms, especially a methyl, ethyl or isopropyl group;
R³ is a linear or branched, cyclic or acyclic alkylene group having 1 to 20 carbon atoms, optionally with aromatic moieties, and optionally with heteroatoms;
R⁴ is a trivalent hydrocarbon radical having 2 to 5 carbon atoms; and
a is 0 or 1.

2. The composition as claimed in claim 1, wherein;
R² is a methyl or ethyl group;
R³ is an alkylene group having 3 carbon atoms;
R⁴ is a trivalent hydrocarbon radical having 2 carbon atoms;
and
a is 0.

3. The composition as claimed in claim 1, wherein the tertiary amine is selected from the group consisting of 1,4-diazabicyclo[2.2.2]octane (DABCO), 1,8-diazabicyclo[5.4.0]undec-7-ene (DBU), 1,5-diazabicyclo[4.3.0]non-5-ene (DBN) and dimorpholino ethers of the formula (II) 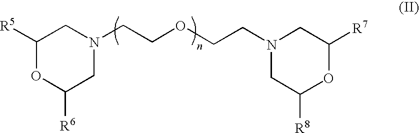
where
R⁵, R⁶, R⁷ and R⁸ are each independently hydrogen atoms or methyl or ethyl groups, and n is from 1 to 10.

4. The composition as claimed in claim 3, wherein the tertiary amine of the formula (II) is 2,2′-dimorpholinodiethyl ether (DMDEE).

5. The composition as claimed in claim 1, wherein the silane of the formula (I) is 3-(trimethoxysilyl)propylsuccinic anhydride or 3-(triethoxysilyl)propylsuccinic anhydride, and the tertiary amine is 2,2′-dimorpholinodiethyl ether (DMDEE).

6. The composition as claimed in claim 1, wherein the proportion of the silane of the formula (I) is 0.05 to 5% by weight of the overall composition.

7. The composition as claimed in claim 1, wherein the proportion of the tertiary amine is 0.05 to 3% by weight of the overall composition.

8. The composition as claimed in claim 1, wherein the composition additionally comprises at least one plasticizer.

9. The composition as claimed in claim 1, wherein the composition additionally comprises at least one rheology modifier.

10. The composition as claimed in claim 1, wherein the composition additionally comprises at least one filler.

11. A method of adhering, sealing or coating objects with the composition as claimed in claim 1.

12. The method as claimed in claim 11, the method further including glazing of modes of transport.

13. The method as claimed in claim 11 for adhesive bonding, sealing and/or coating in construction and industrial applications.

14. A process for adhesive bonding substrates S1 and S2, comprising the steps of
i) applying a composition as claimed in claim 1 to a substrate S1 and/or a substrate S2;
ii) contacting the substrates S1 and S2 through the applied composition;
iii) curing the composition by means of water, especially in the form of air humidity;
the substrates S1 and S2 being the same or different than one another.

15. A process for sealing or for coating, comprising the steps of
i′) applying a composition as claimed in claim 1 to a substrate S1 or between a substrate S1 and a substrate S2;
ii′) curing the composition by means of water, especially in the form of air humidity;
the substrates S1 and S2 being the same or different than one another.

16. The process as claimed in claim 14, wherein a water-containing component, is mixed additionally into the composition on application.

17. The process as claimed in claim 14, wherein at least one of the substrates S1 and S2 is glass or ceramic.

18. The process as claimed in claim 14, wherein one of the substrates S1 and S2 is especially selected from the group consisting of glass, ceramic, glass ceramic, concrete, mortar, brick, tile, gypsum, natural stone such as granite or marble, wood, metal or metal alloy such as aluminum, steel, nonferrous metal or galvanized metal, plastics such as PVC, polycarbonate, PMMA, polyester or epoxy resin, powder coating, paint or paint system.

19. An article which has been adhesive bonded, sealed or coated by a process as claimed in claim 14.

20. The article as claimed in claim 19, wherein the article is a built structure in the form of an industrial good or a consumer good, a domestic appliance, a mode of transport or an installable component of a mode of transport.
